(19) United States
(12) Patent Application Publication
(10) Pub. No.: US 2016/0274316 A1
(43) Pub. Date: Sep. 22, 2016

(54) ACTIVE-OPTICAL IC-PACKAGE SOCKET

(71) Applicant: Samtec, Inc., New Albany, IN (US)

(72) Inventor: Jean-Marc Andre VERDIELL, Atherton, CA (US)

(21) Appl. No.: 15/071,640

(22) Filed: Mar. 16, 2016

Related U.S. Application Data
(60) Provisional application No. 62/134,500, filed on Mar. 17, 2015.

(51) Int. Cl. G02B 6/42; G02B 6/12

(52) U.S. Cl. CPC G02B 6/428; G02B 6/4284; G02B 6/12004; G02B 6/4245; G02B 2006/12142; G02B 2006/12121; G02B 2006/12123

(57) ABSTRACT

A socket for an IC package includes a base with which the IC package is capable of being mated and unmated and an optical element integrated with the base. When the IC package is mated with the base, based on electrical signals received from the IC package, the optical element generates light signals or modifies light signals; and/or based on detected light signals, the socket generates electrical signals that are transmitted to the IC package.

### BACKGROUND OF THE INVENTION

1. Field of the Invention

The present invention relates to integrated circuit (IC) package sockets. More specifically, the present invention relates to active-optical IC-package sockets.

2. Description of the Related Art

IC dies are being made to have more digital input/output (I/O) ports and to operate at higher data rates. The increase in data rates motivates the use of optical fibers to transmit signals between different elements of an electronic system. IC dies can manipulate electronic signals, but not optical signals. Thus, there is a need to package the IC die so that signal integrity of the electronic signals is maintained between the IC die and the optical elements, including electrical-to-optical (E/O) conversion elements and optical-to-electrical conversion (O/E) elements. Generally, the shorter the electrical path between the IC die and the optical elements, the better. Electrical paths should be shielded and impedance-matched as much as possible to maintain signal integrity and to minimize crosstalk. There is a need for an IC package socket that achieves high-data transmission rates in a robust, cost-effective manner.

IC package sockets are known to mount an IC package on a printed circuit board (PCB). Signals from the IC package are then routed through the PCB. Optical elements can be mounted on the PCB near the IC package. However, the electrical path between the IC package and the optical elements is relatively long and has multiple discontinuities in the electrical path due to solder joints, electrical connections, etc. It is also known to mount the IC package adjacent to an optical transceiver. The IC package is permanently mounted, typically with a solder-reflow process. But this requires that the optical transceiver be capable of withstanding solder reflow temperatures, and eliminates the possibility of reworking the IC package if the IC package fails and eliminates the possibility of upgrading the IC package. Testing of the electronic system can be problematic because the integrated system cannot be tested until everything is soldered together. Testing requires specialized optical test equipment.

### SUMMARY OF THE INVENTION

To overcome the problems described above, preferred embodiments of the present invention provide sockets capable of mating and unmating with an IC package, including a short electrical transmission path between the IC die and optical elements, and integrated optical elements. The sockets of the preferred embodiments of the present invention are configured to be tested independently of the IC package; configured to be tested with the IC package mounted in the socket and reworked easily if needed; provide high-bandwidth performance with good signal integrity; and transform any IC package into an optically enabled device.

According to a preferred embodiment of the present invention, a socket for an IC package includes a base with which the IC package is capable of being mated and unmated and an optical element integrated with the base. When the IC package is mated with the base, based on electrical signals received from the IC package, the optical element generates light signals or modifies light signals; and/or based on detected light signals, the socket generates electrical signals that are transmitted to the IC package.

The base preferably includes a photonic layer with an optical modulator. Preferably, light is supplied to the socket from an external laser source, or the socket further includes a laser source integrated into the socket. The socket further preferably includes a driver integrated into the socket that drives an electrical transmission cable.

The base preferably includes compliant electrical contacts that mate and unmate with the IC package. The compliant electrical contacts preferably mate and unmate with sides of the IC package.

The socket further preferably includes an interposer that includes compliant beams and that is located underneath the base. Preferably, the optical element is located underneath the IC package or adjacent to the IC package. The optical element preferably includes at least one of a photodetector and a laser. Preferably, the base is an overmolded base, and the optical element is integrated into the overmolded base.

The socket further preferably includes optical fibers connected to the socket. The socket further preferably includes an electrical transmission cable connected to the socket. The electrical transmission cable is preferably a twinax cable.

According to a preferred embodiment of the present invention, a socket system includes a printed circuit board, the socket according to various preferred embodiments of the present invention connected to the printed circuit board, and an IC package mated with the socket.

The socket system further preferably includes optical fibers connected to the socket. The socket system further preferably includes an electrical transmission cable connected to the socket. The electrical transmission cable is preferably a twinax cable. The electrical transmission cable preferably flies over the printed circuit board. Preferably, the IC package includes an IC die mounted on a substrate, and the substrate includes pads on a surface opposite to the IC die. Preferably, a compressive force maintains electrical contact between the IC package and the socket.

According to a preferred embodiment of the present invention, a socket for an IC package includes a base that the IC package is capable of being connected to. The base includes an optical element, conductive contacts on an upper surface of the base, a trace connecting the optical element and the conductive contacts, vias extending from an upper surface of the base to a lower surface of the base, and an aligner that aligns the IC package with the base when the IC package is connected to the base.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

FIGS. 1 and 2 show an IC package that can be used with the various preferred embodiments of the present invention.

FIGS. 3 and 4 show a socket according to a first preferred embodiment of the present invention.

FIG. 5 shows an IC package inserted into the socket of FIGS. 3 and 4.

FIGS. 6 and 7 show a socket according to a second preferred embodiment of the present invention.

FIG. 8 shows an IC package inserted into the socket of FIGS. 6 and 7.

FIG. 9 shows a socket according to a third preferred embodiment of the present invention.

FIG. 10 shows a socket according to a fourth preferred embodiment of the present invention.

FIG. 11 shows a socket according to fifth preferred embodiment of the present invention.

FIG. 12 shows a socket according to sixth preferred embodiment of the present invention.

FIG. 13 shows a socket according to a seventh preferred embodiment of the present invention.

FIG. 14 shows a first modification of the socket according to the second preferred embodiment of the present invention.

FIGS. 15 and 16 show an IC package that can be used with a second modification of the second preferred embodiment of the present invention.

FIG. 17 shows a second modification of the socket according to the second preferred embodiment of the present invention.

### DETAILED DESCRIPTION OF PREFERRED EMBODIMENTS

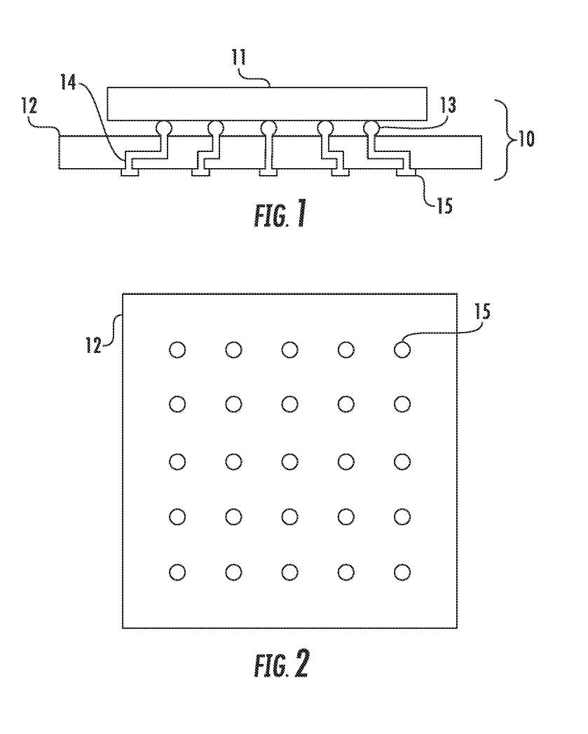

FIGS. 1 and 2 show an IC package 10 that can be used with the preferred embodiments of the present invention. The IC package 10 includes an IC die 11 mounted to a substrate 12 by a ball grid array (BGA) 13. The substrate 12 includes vias 14 that connect the BGA 13 to pads 15. The IC die 11 can be any suitable IC with high-speed I/O data transfer, including, for example, field-programmable gate array (FPGA), microcontroller, microprocessor, application-specific integrated circuit (ASIC), switch, etc. Substrate 12 can be made of any suitable material, including, for example, ceramic, silicon, polymer, etc. The vias 14 are metalized through holes to transmit electrical signals between opposing sides of the substrate 12. The vias 14 can be straight (see the middle via 14 in FIG. 1) or can be non-straight (see the outside vias 14 in FIG. 1). Non-straight vias 14 include vertical vias that are connected by horizontal traces. Non-straight vias 14 allow for signal fan-out from the IC die 11 so that the signal density at the BGA 13 is higher than the signal density at the pads 15. The vias 14 do not have to connect the opposing sides of the substrate 12 and can redistribute the signals on the top and sides of the substrate 12.

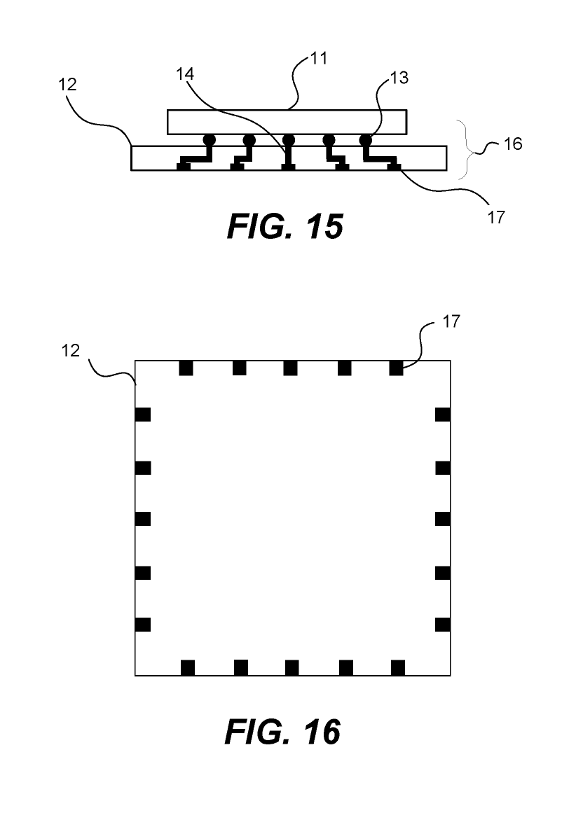

The IC die 11 is typically soldered to the substrate 12 by the BGA 13. Although a 5×5 array is shown in FIG. 2, any suitable size array could be used. The array can be greater than 30×30, for example. The bottom surface of the substrate 12 preferably includes pads 15 arranged in a land grid array (LGA). Other types of pads or contacts could also be used, including, for example, a quad flat no-lead (QFN) contact. The IC package 10 can include pads located on the sides of the substrate 12 similar to the pads 17, as shown, for example, in FIGS. 15 and 16 that show a second modification of the second preferred embodiment of the present invention, instead of and/or in addition to being located on the bottom of the substrate 12. Locating the pads 15 on the sides of the substrate 12 allows the IC package to be inserted into a socket without a compressive force, which reduces the number of hardware components needed. But locating the pads 15 of the sides of the substrate 12 can decrease the signal density.

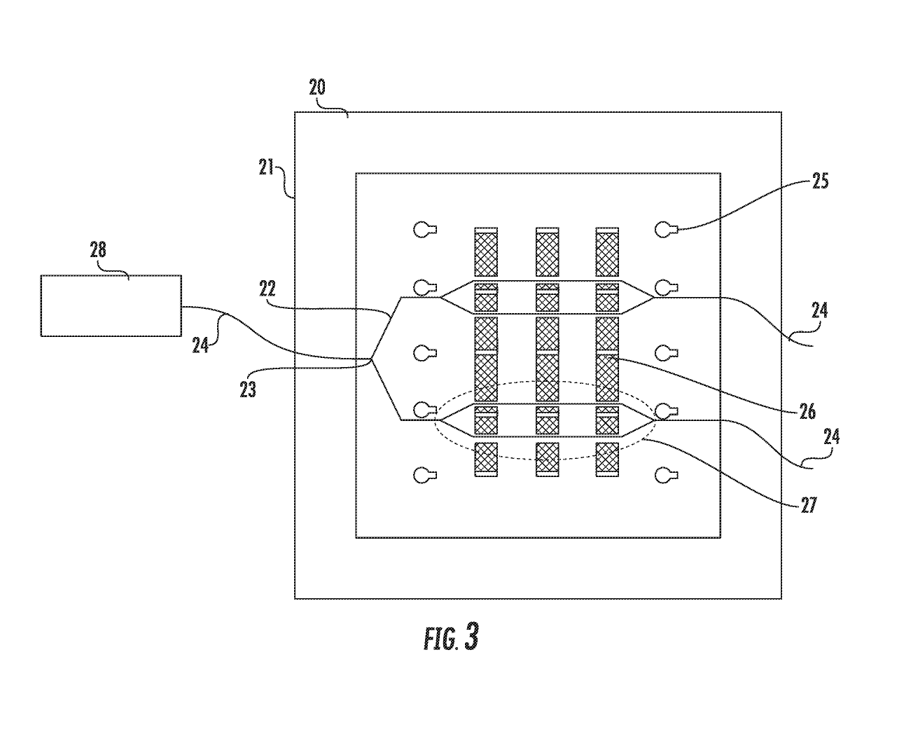

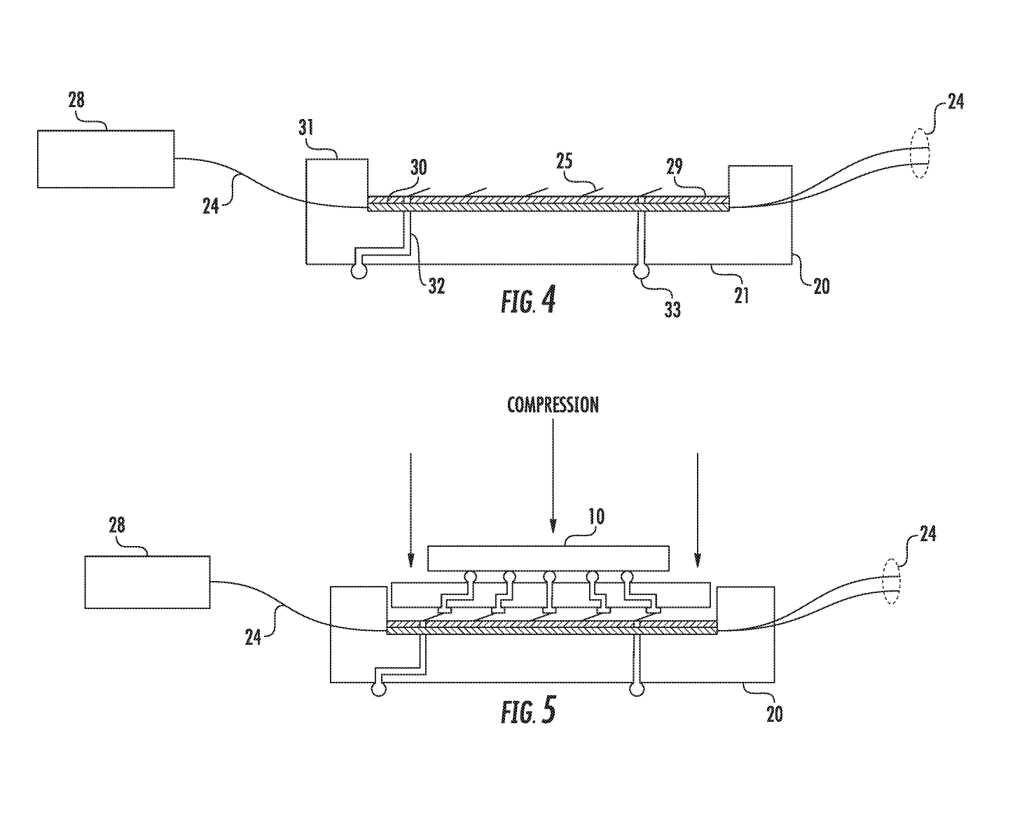

FIGS. 3 and 4 show a socket 20 according to a first preferred embodiment of the present invention. Socket 20 can be mounted to a host PCB (not shown) or other suitable substrate. As shown in FIG. 5, socket 20 receives the IC package 10 of FIG. 1. Socket 20 includes a base 21 and a registration feature 31 that extends upward from the base 21 and that can be used to align the IC package 10 with the socket 20. The base 21 includes vias 32 and a BGA 33. Vias 32 can transport signals between the IC package 10 and the host PCB or substrate. As with vias 15 in the IC package 10, vias 32 of the socket 20 can be straight or non-straight. Non-straight vias 32 include vertical vias that are connected by horizontal traces. Non-straight vias 32 allow for signal fan-out from the IC package 10 so that the signal density at the pads 15 is higher than the signal density at the BGA 33. The vias 32 do not have to connect the opposing sides of the socket 20 and can redistribute the signals on the top and sides of socket 20. BGA 33 can be used to mount the socket 20 to the host PCB or substrate. Socket 20 is not limited to using BGA 33 to electrically and mechanically connect the socket 20 to the host PCB or substrate. It is possible to use other structures or arrangements to electrically and mechanically connect the socket 20 to the host PCB or substrate.

Socket 20 includes both electrical components and optical components. The base 21 can be made of any suitable material or materials, including, for example, one or more of the following injection molded plastic, ceramic, organic materials, silicon, etc. The electrical components can be included in an electronic layer 29. The electronic layer 29 can be made of any suitable material or materials, including, for example, a semiconductor such as Si or GaAs or an insulator with patterned metallic conductive traces. The optical components can be included in a photonic layer 30. The photonic layer 30 can be made of any suitable material or materials, including, for example, typical materials used for photonics integration such as silicon, lithium niobate, indium phosphide, gallium arsenide, and hybrid assemblies of these materials. In FIG. 4, the electronic layer 29 is located above the photonic layer 30, but this arrangement could be reversed. The electronic layer 29 and the photonic layer 30 can also be located on opposite surfaces of the base 21. It is possible to combine the electronic layer 29 and the photonic layers 30, including, for example, in a monolithically integrated silicon photonics device or in a layer in which they are mounted together, either using 3D packaging or using a hybrid method in which they are flip-chip mounted one on top of the other, or in which they are mounted together on an interposer.

The electrical components in the electronic layer 29 of the socket 20 include compliant contacts 25 and traces 26. The compliant contacts 25 are arranged in an array that corresponds to the array of pads 15 on the IC package 25 such that the compliant contacts 25 engage with the pads 15 on the IC package 10, which allows electrical signals to be transported between the IC package 10 and the socket 20. The optical components in the photonic layer 30 of the socket 20 include waveguide 22, splitter 23, and one or more optical elements 27. The traces 26 connect the compliant contacts 25 and the optical elements 27. Optical fibers 24 are connected to the waveguide 22. The optical fibers 24 can be permanently attached to the socket 20 (i.e., pigtailed optical fibers) or can be detachable from the socket 20 (i.e., connecterized optical fibers). As shown in FIG. 3, the waveguide 22 is connected to a splitter 23. A laser source 28 supplies light to the optical fiber 24, which in turn couples the light into waveguide 22. The waveguide 22 is connected to the splitter 23 that splits the waveguide into two waveguides 22. If the optical element 27 is an E/O element such as a modulator, e.g. a Mach-Zehnder modulator, then a digital optical signal can be generated. The digital signal may be generated by the IC package 10 and transmitted to the optical element 27 via compliant contacts 25 and traces 26 thus modulating the light from the laser source 28.

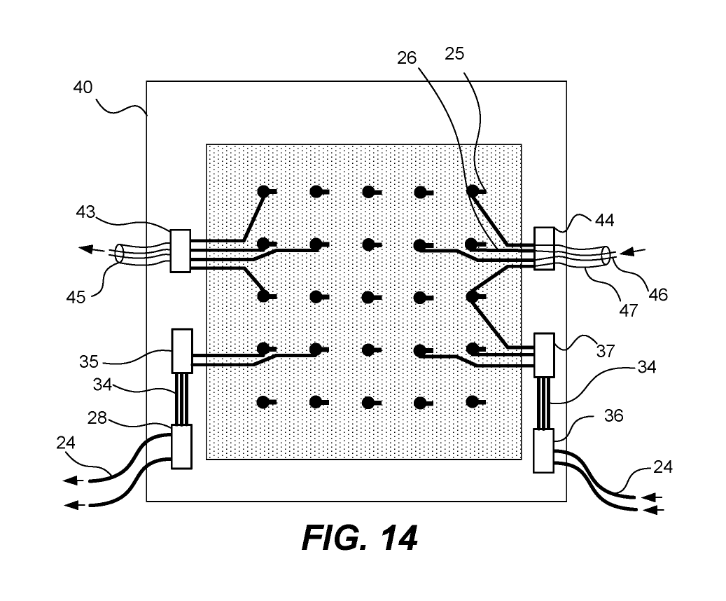

In addition to the optical elements 27, the socket 20 can also include other active elements, including, for example, drivers for electrical transmission cables, such as twin axial (twinax) cables as shown, for example, in FIG. 14 that shows a modification of the second preferred embodiment of the present invention. In such a socket 20, both optical fibers 24 and electrical transmission cables can fly over the host PCB or substrate.

A channel is defined by a single path along which signals are transported, i.e., transmitted and/or received. FIG. 3 shows two channels: the first channel is defined by the upper waveguide 22, and the second channel is defined by the lower waveguide 22. Any number of channels can be used, including one channel and more than two channels. If only one channel is used, then splitter 23 is not needed.

Although only one laser source 28 is shown in FIGS. 3-5, it is possible to use a different number of laser sources 28. For example, in a four-channel socket 20, four laser sources 28 could be used without a splitter 23, or two laser sources 28 and two splitters 23 could be used. The laser source(s) 28 can be located external to the socket 20 as shown in FIGS. 3-5 or can be located within the socket 20. External laser source(s) 28 can reduce the cost and the complexity of the socket 20. Internal laser source(s) 28 might eliminate the need for optical fibers 24 if the light from the laser source(s) 28 is supplied directly to the waveguide 22. If multiple laser sources 28 are used, then the laser sources 28 can have different wavelengths, which allows the optical signals to be multiplexed into and demultiplexed out of a single optical fiber 24. The photonic layer 30 can provide multiplexing and demultiplexing.

As shown in FIG. 5, the IC package 10 is mounted into the socket 20 by a compressive force as shown by the downward arrows in FIG. 5. The compressive force can be supplied by any suitable mechanism, including, for example, a latch (not shown). The compressive force presses the pads 15 of the IC package 10 against the compliant contacts 25 of the socket 20, which provides an electrical connection between the IC package 10 and the socket 20. Only electrical signals are transported between the IC package 10 and the socket 20. No optical signals are transported. Because only electrical signals are transported, the design of the socket can be simplified. Advantageously, preferred embodiments of the present invention can be used with commonly available IC packages, which have no optical transmission capability incorporated into the package.

One or more heatsinks (not shown) can be placed in thermal contact with the IC package 10 and/or the laser source(s) 28. Instead of or in addition to the one or more heatsinks, vias 32 can be arranged to extend through the base 21 to provide a heat conduction path from the IC package 10 to the host PCB.

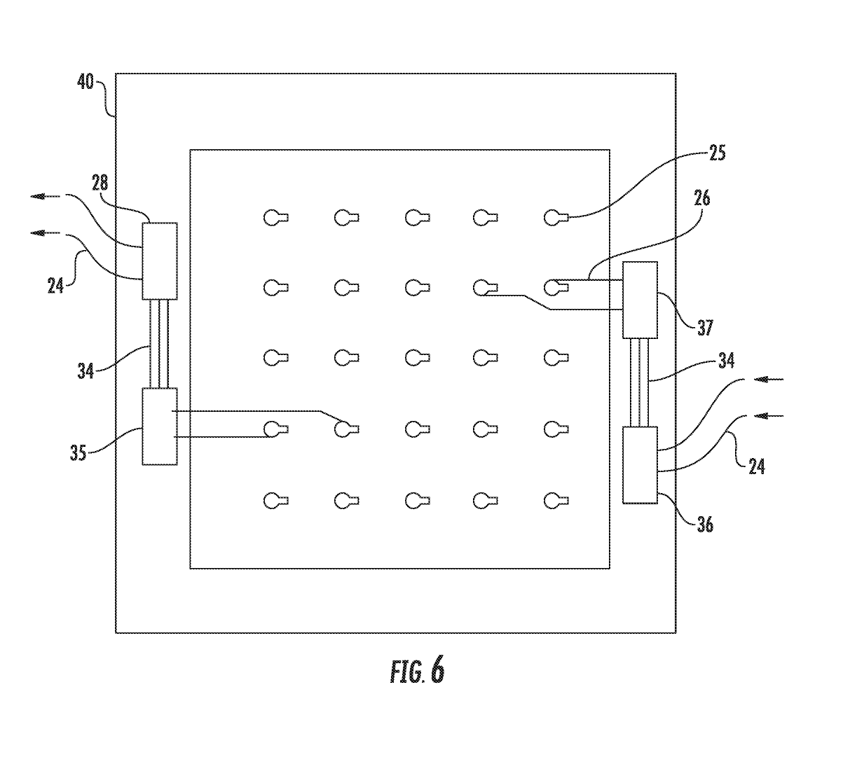

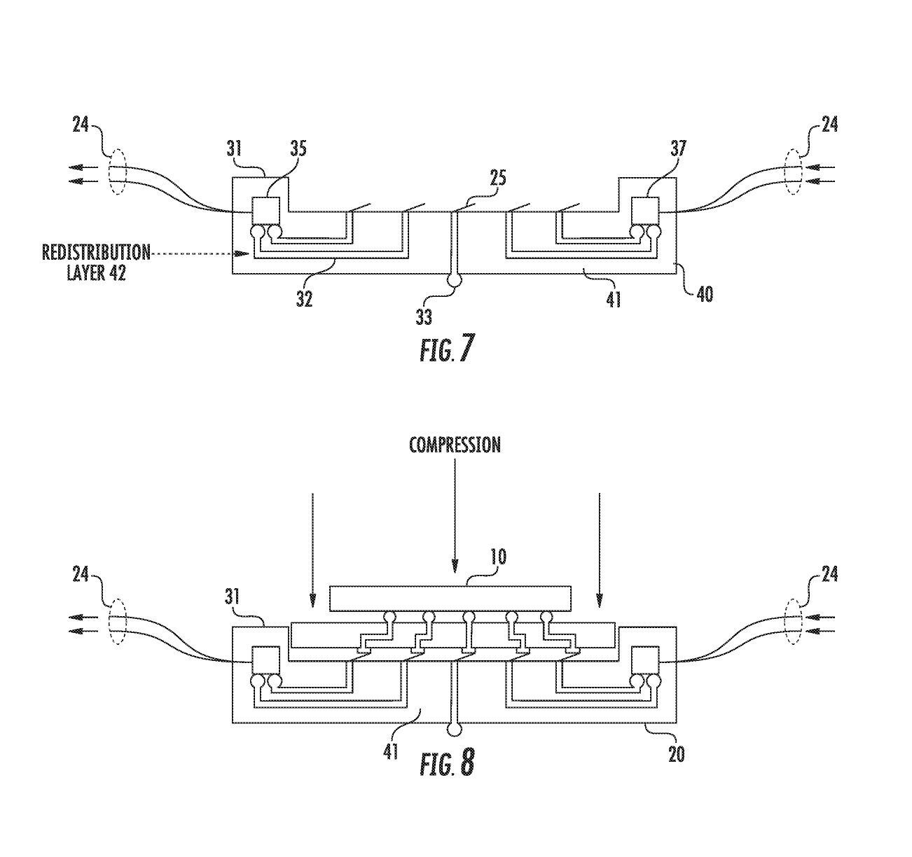

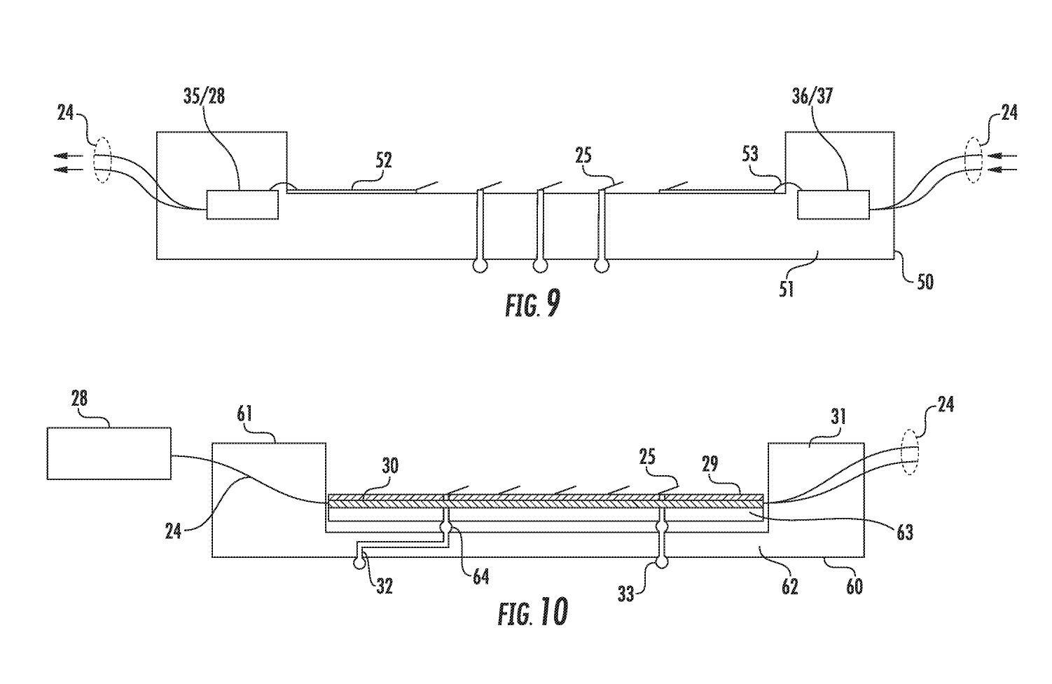

FIGS. 6 and 7 show a socket 40 according to a second preferred embodiment of the present invention. The socket 40 in FIGS. 6 and 7 is similar to the socket 20 in FIGS. 3 and 4, with similar elements being labeled with the same reference numbers. In the socket 40, the optical elements are located within the base 41 and on the side of the base 41 instead of underneath the IC package 10 as in socket 20, which can provide better thermal isolation between the IC package and the optical elements. As shown in FIG. 8, socket 40 receives the IC package 10 of FIG. 1 in a similar manner as socket 20 receives the IC package 10 in FIG. 5.

In FIGS. 6-8, socket 40 includes two channels; however, any number of channels can be used. The channels in socket 40 are defined by the optical fibers 24. A different number of optical fibers 24 can define a different number of channels. Starting on the right-hand side of FIGS. 6-8, for a single channel, an optical fiber 24 provides an optical signal to photodetector 36. A current-based electrical signal is supplied from the photodetector 36 by a trace 34 to the transimpedance amplifier 37, which converts the current-based signal into a voltage-based electrical signal. The voltage-based electrical signal is provided to the IC package 10 through a corresponding complaint contact 25. A corresponding electrical signal is provided by the IC package 10 to the driver 35. The driver 35 provides a driving electrical signal by a trace 34 to the laser 28, which provides a corresponding optical signal that is transported through optical fiber 24. Although the photodetectors 36 and the TIA 37 are shown on one side and the driver 35 and the laser source 28 are shown on the opposite side, it possible that the photodetectors 36, the TIA 37, the driver 35, and the laser source 28 can be on the same side, which can make connecting the optical fibers 24 easier, especially if the optical fibers 24 are provided in a ribbon.

The socket 40 can include a redistribution layer 42. The vias 32 in the redistribution layer 42 can be straight or non-straight. Non-straight vias 32 include vertical vias that are connected by horizontal traces in the redistribution layer. Although a single straight via 32 is shown in FIGS. 7 and 8, the redistribution layer 42 can have more vias 32. The vias 32 of the redistribution layer 42 do not have to connect the opposing sides of the socket 40 and can redistribute the signals on the top and sides of socket 40 as well as providing signals to the optical elements. The redistribution layer 42 can include traces that transport signals between the IC package 10 and the optical elements. The traces in the redistribution layer 42 can include transmission lines to provide impedance matching, which can improve signal integrity.

In FIGS. 3-5, the optical elements include a light source and a modulator, while the optical elements include E/O elements and 0/E elements in FIGS. 6-8. However, the optical elements are not so limited. The optical elements in FIGS. 3-5 can include E/O elements and/or O/E elements, and the optical elements in FIGS. 6-8 can include a light source and a modulator. In addition, other optical elements could also be used.

E/O elements include light sources and supporting electronics. Light sources include vertical-cavity, surface-emitting lasers (VCSELs), edge-emitters, and cw lasers (steady-state) with external modulators, etc. The light sources can be integrated into the socket 20, 40 or can be external to the socket 20, 40. The output of a single light source can be split into different channels, with each channel being separately modulated. If multiple light sources are used and if the light sources have different wavelengths, then the optical signals can be multiplexed into and demultiplexed out of a single optical fiber. Any suitable external modulator can be used, including, for example, Mach-Zehnder modulator, electro-absorption modulator, ring resonator, etc. The external modulator can be made in silicon (i.e., silicon photonics). Supporting electronics can include devices such as drivers, encoding IC (i.e. PAM4, NRZ (non-return to zero), etc.), signal conditioning circuitry, or a gearbox. A gearbox is a device that performs a logic function or that maps data between an input and an output, where the input and output data path lane widths and line rates are not evenly divisible. The gearbox does this by performing multiplexing, demultiplexing, and shift operations on the data signals.

O/E elements include photodetectors and supporting electronics. The photodetectors can be a discrete element or a waveguide. Waveguide photodetector can be made in silicon, i.e., silicon photonics. Supporting electronics include devices such as TIAs, decoding IC, signal conditioning circuitry, or gearbox.

FIG. 14 shows a first modification to the socket 40 according to the second preferred embodiment of the present invention shown in FIGS. 6-8. The socket 40 in FIG. 14 is similar to the socket 40 shown in FIGS. 6-8, but the socket 40 in FIG. 14 includes driver 43 and receptacle 44. The driver 43 and receptacle 44 can be connected to twinax cables 45. The twinax cables 45 include two conductors 46 surrounded by an outer shield 47. Twinax cables 45 transmit differential electrical signals and provide additional receiving/transmitting channels to/from the socket 40. Sockets with twinax cables 45 provide increased flexibility compared to sockets with only optical transmit and/or receive channels. Twinax cables 45 generally support lower bandwidths and shorter signal path lengths compared to optical fibers 24, but these more limited capabilities may be appropriate in some applications because using twinax cables 45 is generally less expensive than using optical fibers 24. Although twinax cables 45 are shown in FIG. 14, other suitable electrical transmission cables can also be used.

Driver 43 can transmit electrical signals between the IC package 10 (not shown in FIG. 14) and the twinax cables 45, and the receptacle 44 can transmit electrical signals between the twinax cables 45 and the IC package 10. Receptacle 44 can permanently connect a twinax cable 45 to the socket 40 or can allow mating and unmating of the twinax cable 45. Preferably, receptacle 44 minimizes the impedance mismatch between the twinax cable 45 and the electrical circuitry of the socket 40, which helps to maintain signal integrity. Although driver 43 and receptacle 44 are shown on opposite sides of the socket 40 in FIG. 14, driver 43 and receptacle 44 can be located in other locations, including, for example, on the same side.

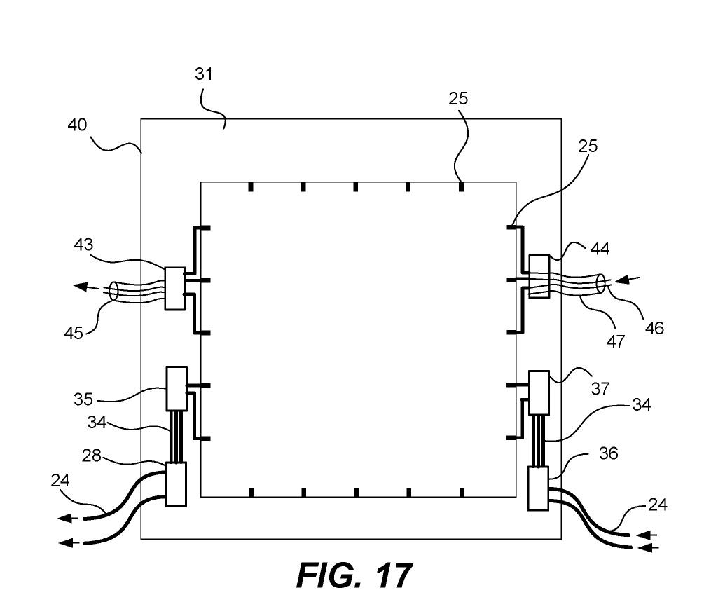

FIG. 17 shows a second modification to the socket 40 according to the second preferred embodiment of the present invention shown in FIGS. 6-8. FIGS. 15 and 16 show an IC package 16 that can be used with the socket 40 shown in FIG. 17. Socket 40 shown in FIG. 17 is similar to the socket 40 shown in FIGS. 6-8 and 14, but the socket 40 shown in FIG. 17 includes compliant contacts 25 arranged only around the inner periphery of the registration feature 31, in addition to the driver 43 and the receptacle 44 of the first modification of the second preferred embodiment of the present invention. Any number of compliant contacts 25 can be used. Generally, the compliant contacts 25 provide electrical contact between the pads 17 shown in FIGS. 15 and 16 and the socket 40 shown in FIG. 17 when the IC package shown in FIGS. 15 and 16 is mated with the socket 40 shown in FIG. 17. In addition to the compliant contacts 25 arranged around the inner periphery of the registration feature 32, it is also possible to arrange compliant contacts 25 in an array in the area inside of the registration feature 31 as shown, for example, in FIGS. 6 and 14. The socket 40 shown in FIG. 17 includes driver 43 and receptacle 44 connected to twinax cables 45, but driver 43 and receptacle 44 are not necessary and can be omitted.

FIG. 9 shows a socket 50 according to a third preferred embodiment of the present invention. The socket 50 shown in FIG. 9 is similar to the socket 40 shown in FIGS. 6-8 in that the optical elements are included in the base 51. The difference between socket 50 and socket 40 is that socket 50 uses wirebonds 53 and traces 52 to transport signals instead of redistribution layer 42. Wirebonds 53 can transport high-speed signals as well as control signals and power. The wirebonds used in FIG. 9 reduces the number of components that need to be flip chip mounted.

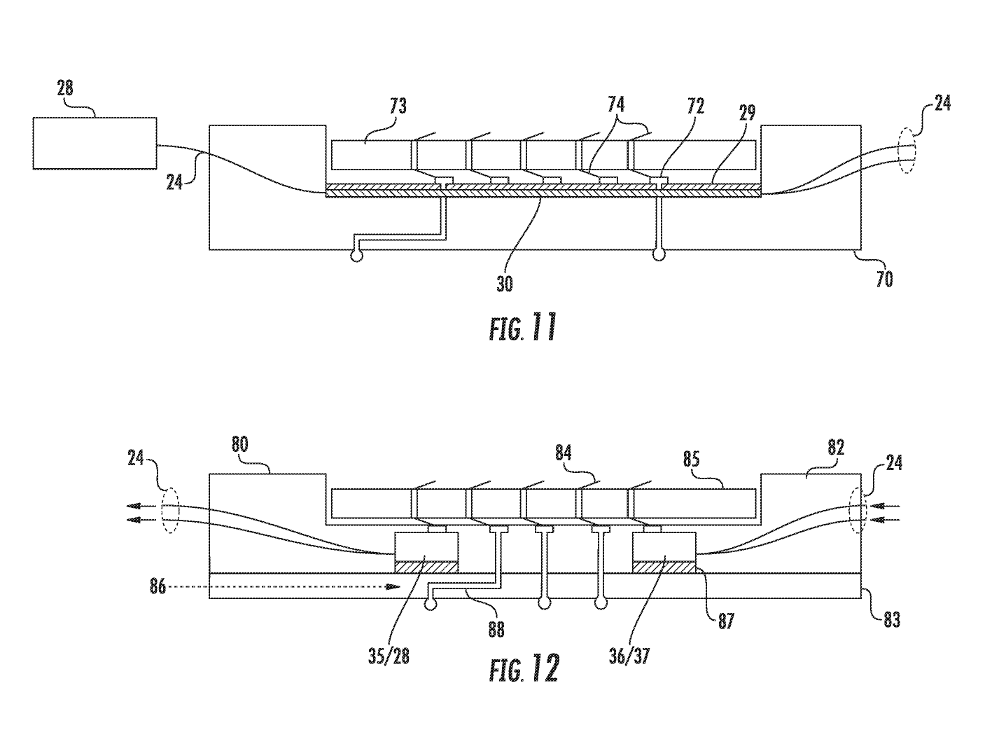

FIG. 10 shows a socket 60 according to a fourth preferred embodiment of the present invention. Socket 60 shown in FIG. 10 is similar to socket 20 shown in FIGS. 3-5. Socket 60 is different in that the base 61 of socket 60 includes a frame 62 and a platform 63 that can be bonded together. The frame 62 and the platform 63 can be bonded together in any suitable manner, including using BGA 64. The platform 63 includes the electronic layer 29 and the photonic layer 30. The frame 62 includes the vias 32 and BGA 33. The frame 62 can also include registration feature 31. The frame 62 and/or the platform 63 can also be fabricated from multiple components bonded together. Dividing the base 61 into frame 62 and platform 63 can make it easier to fabricate or integrate the optical elements. Base 41 in the second preferred embodiment can also be divided into a frame and a platform.

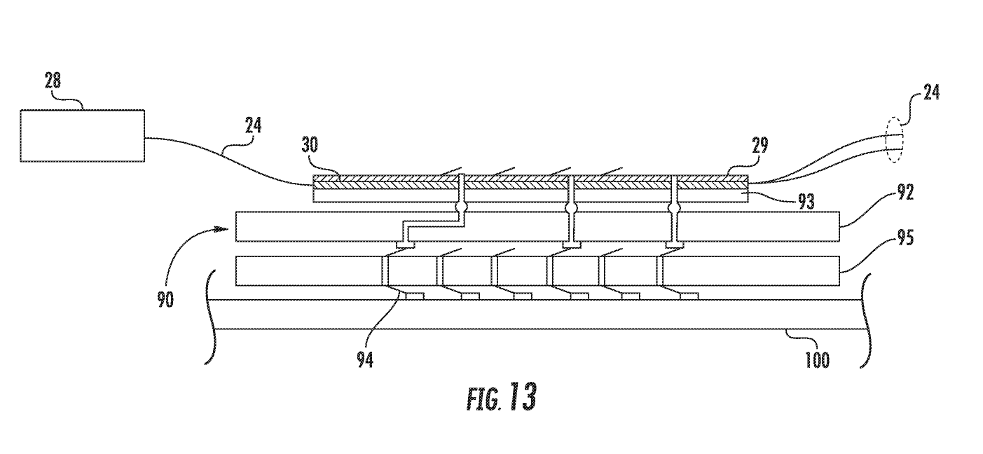

FIG. 11 shows a socket 70 according to fifth preferred embodiment of the present invention. Socket 70 shown in FIG. 11 is similar to socket 20 shown in FIGS. 3-5. Socket 70 is different in that that socket 70 does not use compliant contacts 25. Instead, socket 70 uses pads 72. The pads 72 can be arranged in an LGA. Socket 70 includes an interposer 73 with compliant beams 74. Using pads 72 instead of compliant contacts 25 in the socket 70 and using an interposer 73 with compliant beams 74, reduces the cost and increases the yield of manufacturing the individual components.

FIG. 12 shows a socket 80 according to sixth preferred embodiment of the present invention. Socket 80 shown in FIG. 12 is similar to socket 40 shown in FIGS. 6-8. Socket 80 is different in that optical elements, including, for example, the photodetectors 36, the TIA 37, the driver 35, and the laser source 28, are bonded to platform 83 with adhesive 87 and then frame 82 is molded over the optical elements. Overmolding the optical elements provides a shorter distance between the IC package 10 (not shown in FIG. 12) and the optical elements. The platform 83 can include a redistribution layer 86 in which signals are redistributed using traces 88. Socket 80 can also include an interposer 85 with compliant beams 84 as shown in FIG. 12, or socket 80 can include compliant contacts 25 in a similar arrangement as shown in FIGS. 6-8. Overmolding the frame 82 can shrink the footprint of the socket 80.

FIG. 13 shows a socket 90 according to a seventh preferred embodiment of the present invention. Socket 90 shown in FIG. 13 is similar to socket 60 shown in FIG. 10 in that socket 90 includes frame 92 and platform 93. Socket 90 is different in that it includes an interposer 95 with compliant beams 94 that connect the socket 90 to the PCB 100. Using interposer 95 allows the socket 90 to be replaceable and to be made of a material that does not need to withstand solder-reflow temperatures. Although not shown in FIG. 13, socket 90 can include a registration feature that aligns the IC package 10 with the socket 90. An interposer similar to interposer 90 in between the socket and the host PCB can be used with any of the previous preferred embodiments.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A socket for an IC package comprising:
a base with which the IC package is capable of being mated and unmated; and
an optical element integrated with the base; wherein
when the IC package is mated with the base:
based on electrical signals received from the IC package, the optical element generates light signals or modifies light signals; and/or
based on detected light signals, the socket generates electrical signals that are transmitted to the IC package.

2. The socket of claim 1, wherein the base includes a photonic layer with an optical modulator.

3. The socket of claim 1, wherein light is supplied to the socket from an external laser source.

4. The socket of claim 1, further comprising a laser source integrated into the socket.

5. The socket of claim 1, further comprising a driver integrated into the socket that drives an electrical transmission cable.

6. The socket of claim 1, wherein the base includes compliant electrical contacts that mate and unmate with the IC package.

7. The socket of claim 6, wherein the compliant electrical contacts mate and unmate with sides of the IC package.

8. The socket of claim 1, further comprising an interposer that includes compliant beams and that is located underneath the base.

9. The socket of claim 1, wherein the optical element is located underneath the IC package when the IC package is mated with the socket.

10. The socket of claim 1, wherein the optical element is located adjacent to the IC package.

11. The socket of claim 1, wherein the optical element includes at least one of a photodetector, a modulator, and a laser.

12. The socket of claim 1, wherein:
the base is an overmolded base; and
the optical element is integrated into the overmolded base.

13. The socket system of claim 1, further comprising optical fibers connected to the socket.

14. The socket system of claim 1, further comprising an electrical transmission cable connected to the socket.

15. The socket system of claim 14, wherein the electrical transmission cable is a twinax cable.

16. A socket system comprising:
a printed circuit board;
the socket of claim 1 connected to the printed circuit board; and
an IC package mated with the socket.

17. The socket system of claim 15, further comprising an electrical transmission cable that is connected to the socket and that flies over the printed circuit board.

18. The socket system of claim 13, wherein:
the IC package includes an IC die mounted on a substrate; and
the substrate includes pads on a surface opposite to the IC die.

19. The socket system of claim 13, wherein a compressive force maintains electrical contact between the IC package and the socket.

20. A socket for an IC package comprising:
a base that the IC package is capable of being connected to, the base including:
an optical element;
conductive contacts on an upper surface of the base;
a trace connecting the optical element and the conductive contacts;
vias extending from an upper surface of the base to a lower surface of the base; and
an aligner that aligns the IC package with the base when the IC package is connected to the base.
